(19) United States
(12) Patent Application Publication
(10) Pub. No.: US 2007/0243031 A1
(43) Pub. Date: Oct. 18, 2007

(54) Safety debris collecting device

(76) Inventor: Song-Moon Yun, Honolulu, HI (US)

Correspondence Address: PETER CHIN, P.O. Box 8986, Honolulu, HI, 96830-0986, US

(21) Appl. No.: 11/404,684

(22) Filed: Apr. 14, 2006

(51) Int. Cl. B23B 47/00

(52) U.S. Cl. 408/67

(57) ABSTRACT

The present invention relates to a modular safety debris collecting device for a hand held rotary power tool especially for drilling into construction material such as ceiling, walls, floors, studs, drywall, concrete, wood, metal and masonry. The collecting device protects the power tool or power drill operator and anyone nearby from flung or falling debris ejected from the tool's rotary work element or drill bit. The device has 3 basic modular detachable units, elastic adaptor, flexible, resilient and compressible bellows and debris collector end section. The collector end section stores the adaptor and bellows when not in use.

### BACKGROUND OF THE INVENTION

1. Field of Invention

The present invention relates to a safety debris collecting device for a hand held rotary power tool especially for drilling into construction material such as ceiling, walls, floors, studs, drywall, concrete, wood, metal and masonry. The collecting device protects the power tool or power drill operator and anyone nearby from flung or falling debris ejected from the tool's rotary work element or drill bit. The device also prevents or minimizes the amount of debris that collects on surfaces in the room or work area.

2. Description of the Prior Art

Drilling in construction material produces drilling debris such as dust, shavings, chips and other types of waste matter depending on the construction material. Known debris collecting devices used with drilling or cutting machines or devices prevent or minimize the amount of debris that otherwise would have been flung or fall in the face, head and clothing of the operator of the machine and/or collect on the surfaces in the room or space environment where the work is being performed and nearby areas.

U.S. Pat. No. 3,339,435 (Heitz) discloses an axially compressible bellows type receptacle for collecting chipped material or drillings that is detachably mounted on the drilling machine. The bellows type receptacle is attached to the drill machine through a complicated arrangement of a specially shaped slip-on-sleeve on which the bellow is clamped on, annular sealing member for the drill bit. Two bellows may be combined.

U.S. Pat. No. 5,653,561 (May) discloses a flexible, elastic corrugated frustum shaped swarf boot which collects swarf, i.e., chips from drilling and prevents it from falling into the face, ears, nose, hair and clothing of the operator. The rubber swarf boot is slipped onto the body of the drill and held there by the elasticity of the rubber.

U.S. Pat. No. 5,160,230 (Cuevas) shows a safety debris catcher for a construction tool. The non-rotating debris catcher is connected to a bellows with components that attach it to the working component of the tool, e.g. drill bit.

U.S. Pat. Nos. 5,061,123 and 4,848,980 (Broussard) disclose a dust collector for electric drills. U.S. Pat. No. 4,848,980 is based on a continuation-in-part application of Ser. No. 938,429 filed on Dec. 5, 1986 that subsequently issued as U.S. Pat. No. 5,061,123. The collector has a removable end portion that is preferably transparent for accumulating dust, a collapsible resilient bellows portion (e.g. rubber) with a bottom rim portion that snugly fits over the front end of the electric drill. The transparent end portion has a rubber tip through which the drill bit passes through.

U.S. Pat. No. 4,955,984 (Cuevas) shows a non-rotating safety debris catcher for a tool that has a quick attachment and release feature.

U.S. Pat. No. 3,583,821 (Shaub et al) discloses a flexible and transparent safety guard and chip catcher for a drill.

U.S. Pat. No. 6,814,527 (Fleming) relates to a debris collecting apparatus for hole cutting device. A debris collecting basket through which the hole cutting blade extends through has a sealing ring of felt or foam material.

### BRIEF SUMMARY OF THE INVENTION

The safety debris collecting device of the present invention has a detachable modular structure and capability that permits quick and secure coupling or attachment and detachment of the modular sections (pieces or units) of the safety debris collector device to each other and the assembled safety debris collector device to the body of a hand held rotary power tool having an axially rotating tool element, especially a hand held power drill. The present debris collecting device shields the operator and anyone nearby from debris arising from the operation of the rotary tool work element such as a drill bit. It gives the tool operator the option of not using encumbering eye goggles and/or dust masks. The present device has features that allow for quick release and disposal of the collected debris such as dust, shavings, chips and other types of waste matter depending on the construction material. The safety debris collecting device can be easily stored in a single compact unit that saves space and is easily packaged and marketed as a single compact unit. There is also a sealing feature that provides additional protection against debris escaping from the collecting device and hitting or falling into the face, head and clothing of the tool operator and anyone nearby. Since there is no or minimal escape of debris into the environment, no or minimal clean-up is required, an advantage for work performed in occupied space, e.g. a room with furnishings with or without people.

The safety debris collecting device in its general configuration comprises three separate basic modular components: a detachable tool adaptor section (piece or unit), a detachable bellows section (piece or unit) and a detachable two-part debris collector end section (piece or unit) for collecting the debris, seating and sealing the collector against the work surface during operation of the tool to prevent escape of debris. The two part debris collector end section serves as a container for the bellows section and adaptor section when the safety debris collecting device is not in use or for marketing purposes.

The tool adaptor section (piece or unit) is of an elastic material such as synthetic or natural or silicone rubber, one end of which slips over and tightly secures itself to the non-moving portion of the tool housing by frictional/compressional and/or elastic tension. The other end of the adaptor is secured to one end of the bellows piece. The other end of the bellows is connected and secured to one end of the two-piece debris collector end piece.

The bellows is flexible, resilient and compressible. It can be made of an elastic rubber-like material such as synthetic, natural or silicone rubber. It is however, preferably made of a thermoplastic material such as polyester (PET), polyamide, polyethylene, polypropylene or polystyrene and other thermoplastic polymers having properties similar to the aforementioned thermoplastics. The corrugations of the bellows may be either parallel or spiral/helical configuration.

The two piece collector end piece is suitably dimensioned and shaped to receive debris from the operation of the rotary tool element such as a drill bit and to accommodate and fit the adaptor piece and bellows in compressed state when the safety debris collecting device is not in use, e.g. in storage. The end of the two piece debris collector piece proximal to or abutting the work surface (such as a wall or ceiling) preferably has resilient means to seal and prevent the escape of the debris from the safety debris collecting device into the environment and the face, head and clothing of the tool operator. This feature allows the inventive collecting device to be used on both smooth and rough or uneven work surfaces. At least one piece of the two-piece debris collector is transparent to allow the operator to see and accurately position the rotating tool element onto the work surface.

The modular or sectional design of the safety debris collector device allows for easy servicing, cleaning and replacement of one or more pieces or sections of the device.

### BRIEF DESCRIPTION OF THE DRAWINGS

FIG. 1 is an exploded side elevation view of the safety debris collecting device of the present invention.

FIG. 2 is a side elevation view of the safety debris collecting device of the present invention in assembled condition.

FIG. 3 is a side elevation view showing the safety debris collecting device disassembled and stored inside the two part debris collector end section.

FIG. 4 is a bottom plan view of FIG. 3

FIG. 5 is a top plan view of FIG. 3

FIG. 6 is an enlarged view of circled area 6 in FIG. 1.

FIG. 7 is a cross sectional view of the safety debris collecting device in use.

FIG. 8 is a side elevation view of a tapered adaptor.

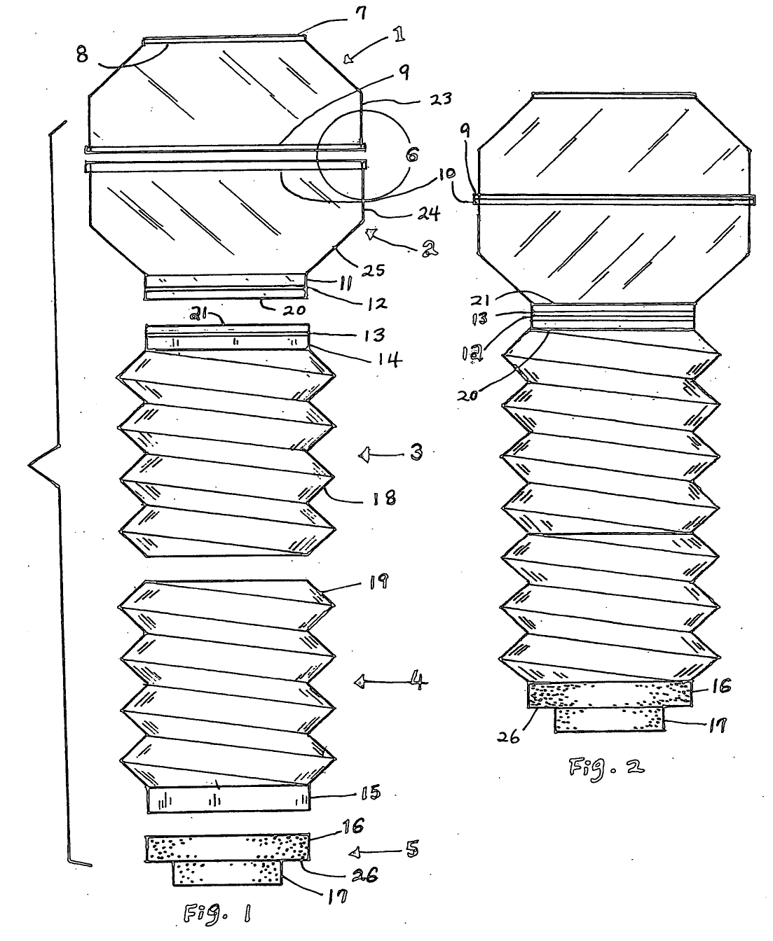

### DETAILED DESCRIPTION OF THE INVENTION

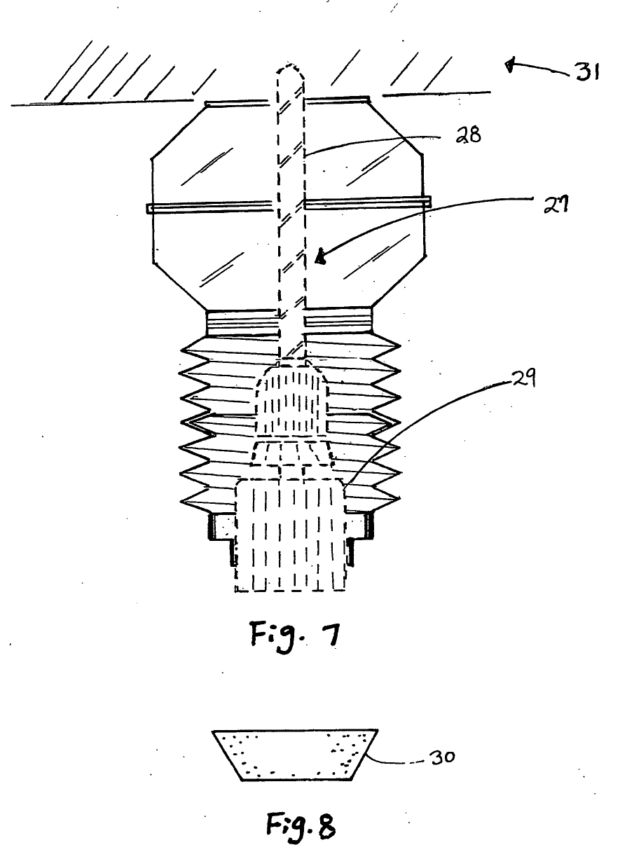

The safety debris collecting device of the present invention comprises three basic quick detachable modular sections (pieces or units): adaptor, bellows and two part debris collecting end sections. The bellows compresses and exerts pressure on the debris collecting end section to seat and seal the safety debris collecting device against the work surface as the power tool 27 is operated and urged against the work surface (FIG. 7).

The adaptor section 5 is constructed of an elastic material as described above. It is suitably sized or dimensioned to detachably couple or secure the bellows section 3 to the non-moving body portion of the hand held power rotary tool such as a hand held power drill 27 and to the bellows. It may be a simple strip or band of the elastic material or can have portions in a “step-like” structure 5, the cross sectional shape of which does not have to be circular, i.e., concentric as long as the bottom portion 17 of the step like structure that engages the tool body surface is narrower in cross section than the other portion. Another embodiment is the tapered or truncated cone shaped adaptor 30 shown in FIG. 8. The adaptor is dimensioned such that its inner contacts the surface of the tool body and overlaps the lower end of the bellows thereby securing the bellows and hence the safety debris collecting device to the tool. The adaptor advantageously imparts flexibility that allows the inventive safety debris collecting device to be securely attached to power tool bodies of various cross sectional shapes and sizes.

The bellows section can have parallel corrugations have helical or spiral corrugations as shown in Figures. One end portion of bellows section 15 and one end portion of adaptor section 16 are suitably configured to engage and detachably attach to each other. Bellows 4 has an extension or lip portion 15 at its lower end that provides an engagement surface for the adaptor section to attach to. The bellows section can be of elastic material or thermoplastic material as described above. The preferred material is thermoplastic especially polyester (PET). It can be transparent and have any desired color.

The other end portion of bellows has means to detachably couple and secure the bellows to the debris collector end section. This may be accomplished by elastic tension or friction fit between bellows end portion with a connecting or connector end portion of debris collector. Another form of coupling is made by providing by cooperating screw thread or twist structure on the respective connector or connecting portions of the respective bellows section and the two part debris collecting end section. The structural arrangements of the connector portions of each of the two sections cooperate to form snap-on, twist-on or screw-on or bayonet type connection or friction fit. A preferred means for detachable connection of these two sections is by a suitable snap-on engagement structure. The lip or connector portion 14 of upper end of bellows has an integrally molded ring-like, or recessed or groove structure 13 to receive the locking integrally molded ring-like structure 12 of a connector portion 11 of the debris collector end section 1, the groove structure and the ring-like structure can be reversed for the connector portions. It is noted that these connector portions (11, 14) can be modified to provide the other types of coupling structure, friction/elastic, threaded or twist-on, bayonet mount. The area of the lip portion and/or the corresponding ring-like structure, i.e., the area of the section that is in contact to form the connection with the other section may be reinforced or made more rigid by thickening the material in this area(s) to improve life and performance of these sections.

The bellows should be of sufficient length in its uncompressed state such that the tip of the rotating tool element, e.g. drill bit does not substantially extend beyond the end opening of the debris collector end section that contacts the work surface.

A bellows extension 4 can be used when extra length is desired. The bellows extension may be corrugated and have the same or matching corrugations to the corrugated bellows 3. The bellows extension or bellows may be color coded with the sections to facilitate assembly. For example, if the bellows extension couples to the adaptor, the extension will have same color as the adaptor. This is of course a non-limiting example of color coding and any color sequence can be used.

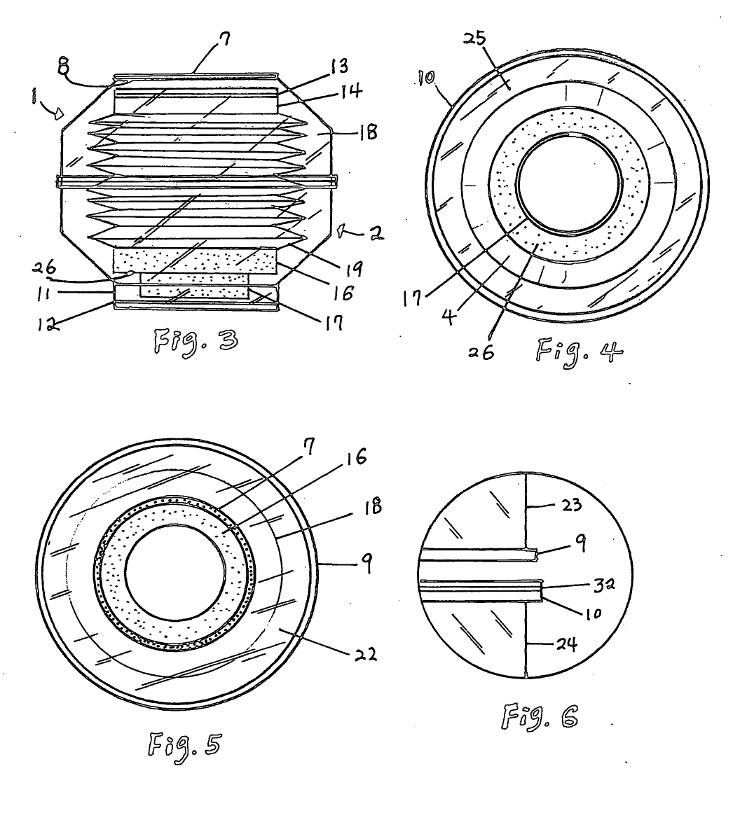

The two part debris collector end section (1,2) is shaped and dimensioned to collect debris from the operation of hand held power rotary tool such as a hand held power drill and to accommodate and allow the rotating work element, the drill bit to contact and perform work on the work surface. It should be sufficient size to accommodate or fit and contain the adaptor and bellows section in compressed condition to enable easy compact storage as shown in FIG. 3 and facilitates easy packaging for marketing.

The two part debris collector is generally of a bowl-like shape, that is, the walls of the collector are tapered outwardly from area where it is coupled to the bellows section and tapers inwardly toward the opening where the debris collector section seats against the work surface. Thus, the walls of two part debris collector end section are suitably curved, convex, concave or have truncated conical shape.

The two parts (1,2) are detachably held together by friction fit, bayonet, screw thread or snap-on modification of the mating edge portions of the two parts. The first part 1 has a flange or lip extension 9 that co-acts with ring-like element 32 of connector portion 10 of the second part 2 to attach part 1 to part 2 of the two part debris collector end section. The structural arrangements of the extensions and elements of the connector portions of each of the two sections cooperate to form snap-on, twist-on or screw-on or bayonet type connection or friction fit. A preferred means for detachable connection of these two sections is by a suitable snap-on engagement structure.

The embodiment of the two part debris collector end section shown in the drawings has both parts being transparent. The second part 2 has a conical wall 25 extending from the first connector portion 11 and joins and merges with a generally cylindrical wall 24, a second connector portion 10 located at the opposite end has structure that co-act with structure of a connector portion 9 of the first part 1 of the two part debris collector to detachably attach the first part to the second part of the two part debris collector section. The connector portion for detachably attaching the second part to the first part is located at one end of a generally cylindrical wall 23 that joins and merges with a conical wall 22 that terminates to form the opening or mouth 8 of the debris collector section, the opening that seats against the work surface. It is noted that the one or both conical walls may be replaced by a curved, convex or concave wall. Each part can be suitably molded as a single unitary piece.

At least one part of the two part debris collector end section is transparent to allow the operator to see and accurately place the rotating work element, e.g., drill bit on the work surface. It is preferred that both parts are transparent. It is suitably made of plastic. A preferred material is polyester or PET.

Another embodiment provides the work contacting edge at the opening of the debris collector section with a coextensive resiliently compressible material such as felt or foam material of plastic or rubber or rubber-like material to further improve seating and sealing of the safety debris collecting device against the work surface. This feature enhances the seal of the debris collector end section and a work surface having smooth or uneven or rough surface.

The areas corresponding to the connecting or connector portions of each section can be reinforced or made more rigid as by thickening one or more portion thereby improving life and performance of the sections

The inventive safety debris collecting device can be easily disassembled and stored. The adaptor section, compressed bellows section are easily fit into the interior of the two part debris collector end section to form a single compact unit ready for storage or marketing as shown in FIG. 3.

The present invention further contemplates an additional aspect, which is the use of color. Each section of the modular safety debris collecting device can be of the same color or of different colors. The sections may be color coded to aid in assembly and for replacement purposes.

Modifications, variations and changes may be made which does depart from the spirit and scope of present invention.

1. A modular safety debris collecting device for a hand held power rotary tool having an axially rotating tool element, comprising a elastic tool adaptor section detachable coupled to a resilient, flexible and compressible corrugated bellows section, said bellows section detachable coupled to a two part debris collector end section; said elastic adaptor section shaped and dimensioned to elastically couple said bellows to a body of the hand held power rotary tool; said two part debris collector end section having at least one of said part is sufficiently transparent to allow a tool operator to view and place the axially rotating tool element of the hand held power rotary tool onto a work surface, said two part debris collector end section having an open end to allow passage of a rotary tool work element and seat against a work surface, said two part debris collector section being shaped and dimensioned to contain the debris from the operation of the rotary work element and to at least contain said adaptor section, compressed bellows section when said modular safety debris collecting device is disassembled for storage or marketing and each part of said two part debris collecting section being detachably attached to one another.

2. The modular safety debris collecting device of claim 1, wherein the hand held power rotary tool is a power drill.

3. The modular safety debris collecting device of claim 1, wherein said elastic adaptor section comprises at least a first and a second adaptor portions in a step configuration, said first adaptor portion of said adaptor to receive and engage the tool body, the second portion of said adaptor receives an end of said bellows section, the first portion being narrower than the second portion.

4. The modular safety debris collecting device of claim 1, wherein said elastic adaptor section comprises an elastic strip.

5. The modular safety debris collecting device of claim 1, wherein said elastic adaptor section comprises a tapered shape

6. The modular safety debris collecting device of claim 1, wherein said elastic adaptor section comprises a truncated cone shape.

7. The modular safety debris collecting device of claim 1, wherein said corrugated bellows section have substantially parallel, helical or spiral corrugations.

8. The modular safety debris collecting device of claim 7, wherein said corrugated bellows section have substantially helical or spiral corrugations.

9. The modular safety debris collecting device of claim 1, wherein an extension bellows is detachably coupled to said corrugated bellows section for extending length of said modular safety debris collecting device.

10. The modular safety debris collecting device of claim 9, wherein said extension bellows has the same type of corrugation as said corrugated bellows section.

11. The modular safety debris collecting device of claim 1, wherein an end portion of said corrugated bellows section comprises means for co-acting with means on said two part debris collector end section to form a snap-on connection to detachably couple said bellows to said two part debris collector end section.

12. The modular safety debris collecting device of claim 1, wherein an end portion of said corrugated bellows section comprises co-acting threaded means to mate with a thread receiving means in said two part debris collector end section to detachably couple said corrugated bellows section to said two part debris collector end section.

13. The modular safety debris collecting device of claim 1, wherein an end portion of said corrugated bellows section comprises means for co-acting with means on said two part debris collector end section to form a bayonet mounting to detachably couple said corrugated bellows section with said two part debris collector end section.

14. The modular safety debris collecting device of claim 1, wherein an end portion of said corrugated bellows section comprises means for co-acting with means on said two part debris collector end section to form a friction fit to detachably couple said corrugated bellows section to said two part debris collector end section.

15. The modular safety debris collecting device of claim 1, wherein at least one of said corrugated bellows section and two part debris collector end section is comprised of a thermoplastic material that is optionally transparent.

16. The modular safety debris collecting device of claim 15, wherein both of said corrugated bellows section and two part debris collecting end section are comprised of said thermoplastic material that is optionally transparent.

17. The modular safety debris collecting device of claims 15, wherein said thermoplastic material that is optionally transparent comprises polyester.

18. The modular safety debris collecting device of claims 16, wherein said thermoplastic material that is optionally transparent comprises polyester.

19. The modular safety debris collecting device of claim 1, wherein said corrugated bellows section is comprised of an elastic material.

20. The modular safety debris collecting device of claim 1, wherein said debris collecting end section comprises a first part and an opposing second part, said first part and opposing second part have detachable means that co-act to form a snap-on attachment of said first part to said second part of said two part debris collecting end piece.

21. The modular safety debris collecting device of claim 1, wherein said debris collecting end section comprises a first part and an opposing second part, said first part and opposing second part have detachable means that co-act to form a threaded screw or twist-on attachment of said first part and said second part of said two part debris collecting end section.

22. The modular safety debris collecting device of claim 1, wherein said debris collecting end section comprises a first part and an opposing second part, said first part and opposing second part have detachable means that co-act to form a bayonet attachment of said first part to said second part of said two part debris collecting end section.

23. The modular safety debris collecting device of claim 1, wherein said debris collecting end section comprises a first part and an opposing second part, said first part and opposing second part have detachable means that co-act to form a friction fit attachment of said first part to said second part of said two part debris collecting end section.

24. The modular safety debris collecting device of claim 1, wherein said two part has a first part and a second part, said first part having at one end a connector portion with structure that co-acts with a structure on said bellows to detachably couple said two part debris collector section to said bellows section, a wall tapers outwardly from said connector portion of said first part and joins a cylindrical wall, said cylindrical wall of said first part has an upper end portion with structure that co-acts with structure in an upper end portion of a cylindrical wall of said second part to detachably attach said first part to said second part of the two part debris collector end section, said cylindrical wall of said second part joins a inwardly tapered wall that terminates in an edge to define an opening for seating against a work surface.

25. The modular safety debris collecting device of claim 23, wherein said edge has a resilient felt or foam material positioned thereon for resilient engaging said work surface and improve sealing against the work surface.

26. The modular safety debris collecting device of claim 23, wherein the tapered wall of said first part or tapered wall of said second part or both is/are curved or truncated conical shaped.

27. The modular safety debris collecting device of claim 1, wherein both parts of said two part debris collector end section are transparent.

28. The modular safety debris collecting device of claim 1, wherein said adaptor section, corrugated bellows section and said debris collector end section are colored the same or differently.

29. The modular safety debris collecting device of claim 26, wherein the color used is for color coded assembly of said adaptor section, corrugated bellows section and debris collector section.
